(19) United States
(12) Patent Application Publication
(10) Pub. No.: US 2006/0218747 A1
(43) Pub. Date: Oct. 5, 2006

(54) Apparatus for protecting a door, door casing, knob and wall utilizing a door bump angled block

(76) Inventors: Jonathan Davis, Powder Springs, GA (US); Rebecca Davis, Powder Springs, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/552,846

(22) PCT Filed: Apr. 12, 2004
(86) PCT No.: PCT/US04/11194

§ 371 Date: Oct. 12, 2005

(30) Foreign Application Priority Data
Apr. 12, 2003 (US) 10/411,736

(51) Int. Cl. E05F 3/00

(52) U.S. Cl. 16/49

(57) ABSTRACT

An apparatus and method for protecting a door, door casing, door knob and wall utilizing a door bump angled block, wherein the apparatus and method changes the orientation of a door bump relative to the door and wall. The apparatus and method of the present invention allows a door bump to contact the door or wall squarely, thus allowing the door bump to effectively dissipate the forces generated when the door or wall strikes the door bump. Further, the apparatus and method of the present invention allows the user to adjust the extent to which a door may be opened by varying the position of the door bump, thereby protecting the door, door casing, door knob, wall and abutting objects.

### PRIORITY CLAIM

The present patent cooperation treaty application claims the benefit of a U.S. non-provisional application entitled “apparatus and method for protecting a door, door casing, door knob and wall utilizing a door bump angled block,” filed Apr. 12, 2003, having assigned U.S. Ser. No. 10/411,736.

### TECHNICAL FIELD

The present invention relates generally to protection of doors, door casings, door knobs and walls, and more specifically to an apparatus and method of protecting doors, door casings, door knobs and walls utilizing a door bump angled block to change the position of the door bump in relation to the door and wall.

### BACKGROUND OF THE INVENTION

Often times, door surfaces, door casings, door knobs and wall surfaces become scratched, dented, and/or suffer from any number of cosmetic damages that unfortunately degrade the external aesthetic appearance of the room or hallway. In order to prevent the door or door knob from engaging an adjacent wall or surface, a door bump is often used. One type of door bump is secured to the wall and positioned in registry with the door such that the door contacts the door bump when the door is opened, thus preventing direct contact between the door or door knob and the wall or door casing. Alternatively, the door bump may be secured to the door, such that when the door is fully opened, the door bump contacts the wall at a generally 90 degree angle.

Typically, such door bumps effectively dissipate the forces generated when the door strikes the door bump. However, such door bumps are not effective at protecting doors, door casings, door knobs and/or wall surfaces unless the door opens such that it approaches the door bump and is perpendicular to the door bump when making contact-therewith. In those instances when the opening force of the door is minimal, such prior-art door bumps adequately protect the wall, door and its surrounding members. However, because the door or wall does not contact the door bump squarely, when the opening force of the door is more than minimal, the door or wall will bend and push aside the door bump, causing damage to the door or door knob and/or wall or door casing. Consequently, it is highly desirable to provide an apparatus and method for changing the position of the door bump relative to the door or wall so that the door or wall will contact the door bump squarely.

Doors, door casings, door knobs and walls are also damaged when opening doors swing out too far. For example, when an object or large appliance is positioned behind and adjacent to an opening door, it is located in the path of the swinging door and may be damaged or destroyed. Doorways with abutting objects are common and often unavoidable in smaller rooms. Previous door bumps, no matter where they are positioned on the door or wall, are often not able to protect or prevent the door from striking the abutting object.

Consequently, various forms of hinge pin mounted door stops have been designed to adjust the extent to which an associated door may be opened. However, these various adjustment structures cause extensive damage to doors, door casings, and walls. After several uses, noticeable wear can be seen on doors, door casings, and walls. Shortly thereafter, dents and holes appear at the points where the hinge pin mounted door stop contacts the door, door casing, and/or wall.

Additionally, many hinge pin mounted door stops crack or split only after moderate use. Many hinge pin mounted door stops are not able to dissipate the forces generated during regular use, putting substantial pressure on the door stop.

Unfortunately, without engaging in unduly expensive and burdensome repair or replacement of such doors, door casings, door knobs and walls to remedy the above-addressed cosmetic concerns, many homeowners are left without any cost-effective or feasible avenue in which to remedy same.

Therefore, it is readily apparent that there is a need for an apparatus and method for changing the position of the door bump relative to the door or wall so that the door or wall will contact the door bump squarely and so that the extent to which a door may be opened may be adjusted.

### BRIEF SUMMARY OF THE INVENTION

Briefly described, in a preferred embodiment, the present invention overcomes the above-mentioned disadvantages and meets the recognized need for such a device by providing an apparatus and method of protecting doors, door casings, door knobs and walls. This is achieved in the present invention by using a door bump angled block to change the angular position of the door bump relative to the door and wall. Changing the angular position of the door bump to contact the door squarely allows the door bump to effectively dissipate the forces generated when the door strikes the door bump. Changing the angular position of the door bump can also adjust the extent to which a door may be opened, thereby protecting the door, door casing, door knob, wall and abutting objects.

The door bump angled block has an angled surface relative to the wall mounted surface. Formed within the door bump angled block are preferably two channels, wherein one channel is preferably used to fasten the door bump angled block into the door or wall, and wherein one channel is preferably used to fasten a door bump connector plate to the door bump angled block.

Accordingly, a feature and advantage of the present invention is its ability to change the position of the door bump to contact the door squarely, thereby allowing the door bump to effectively dissipate the forces generated when the door or wall strikes the door bump.

Another feature and advantage of the present invention is its ability to change the position of the door bump allowing the user to adjust the extent to which a door may be opened, thereby protecting the door, door casing, door knob, wall and abutting object.

Another feature and advantage of the present invention is its ability to adjust the angular position of the door bump relative to the mounting surface, thereby allowing the user to use this device on any door or wall in a building.

Another feature and advantage of the present invention is that it can be used with any type of readily available door bump.

Another feature and advantage of the present invention is that it is simple to manufacture and use.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1A is a top view of an apparatus for protecting a door, door casing, door knob and wall according to a preferred embodiment of the present invention, wherein said apparatus is mounted to the wall in such a way that it will contact the door squarely;

FIG. 1B is a top view of an apparatus for protecting a door, door casing, door knob and wall according to a preferred embodiment of the present invention, wherein said apparatus is mounted to the wall in such a way that the extent to which the door may be opened may be adjusted;

FIG. 1C is a top view of an apparatus for protecting a door, door casing, door knob and wall according to an alternate embodiment of the present invention, wherein said apparatus is a door bump with a non-perpendicularly angled distal end;

FIG. 2 is a front perspective view of a door bump angled block according to a preferred embodiment of the present invention;

FIG. 3 is a rear perspective view of a door bump angled block according to a preferred embodiment of the present invention;

FIG. 4A is a cross sectional exploded side view of an apparatus for protecting a door, door casing, door knob and wall according to a preferred embodiment of the present invention, wherein screws are used to attach the door bump angled block to the wall or door, and to attach the connector plate to the door bump angled block;

FIG. 4B is a top view of a door bump connector plate according to a preferred embodiment of the present invention, wherein preferably disposed on said connector plate are two apertures;

FIG. 5 is a top view of an apparatus for protecting a door, door casing, door knob and wall according to an alternate embodiment of the present invention, wherein the door bump is pivotable along a horizontal axis;

FIG. 6A is a top view of an apparatus for protecting a door, door casing, door knob and wall according to an alternate embodiment of the present invention, wherein the door bump is pivotable along a horizontal axis;

FIG. 6B is a front view of a door bump angled block according to an alternate embodiment of the present invention, wherein a base connector is pivotable along the outer surface of said door bump angled block;

FIG. 7 is a top view of an apparatus for protecting a door, door casing, door knob and wall according to an alternate embodiment of the present invention, wherein the door bump is pivotable along a horizontal axis;

FIG. 8 is a top view of an apparatus for protecting a door, door casing, door knob and wall according to an alternate embodiment of the present invention, wherein the door bump is pivotable along a horizontal axis;

FIG. 9 is a front view of a door bump angled block according to an alternate embodiment of the present invention, wherein a door bump can be attached to said door bump angled block;

FIG. 10 is a top view of an apparatus for protecting a door, door casing, door knob and wall according to an alternate embodiment of the present invention, wherein the door bump is pivotable along a horizontal axis;

FIG. 11 is a side view of an apparatus for protecting a door, door casing, door knob and wall according to an alternate embodiment of the present invention, wherein the door bump is pivotable along a horizontal axis;

FIG. 12 is a top view of an apparatus for protecting a door, door casing, door knob and wall according to an alternate embodiment of the present invention, wherein said apparatus can be mounted to the wall in such a way that it will contact the door squarely; and

FIG. 13 is a top view of an apparatus for protecting a door, door casing, door knob and wall according to an alternate embodiment of the present invention, wherein said apparatus can be mounted to the wall in such a way that it will contact the door squarely.

### DETAILED DESCRIPTION OF THE PREFERRED AND SELECTED ALTERNATIVE EMBODIMENTS

The present patent cooperation treaty application claims the benefit of a U.S. non-provisional application entitled “apparatus and method for protecting a door, door casing, door knob and wall utilizing a door bump angled block,” filed Apr. 12, 2003, having assigned U.S. Ser. No. 10/411,736.

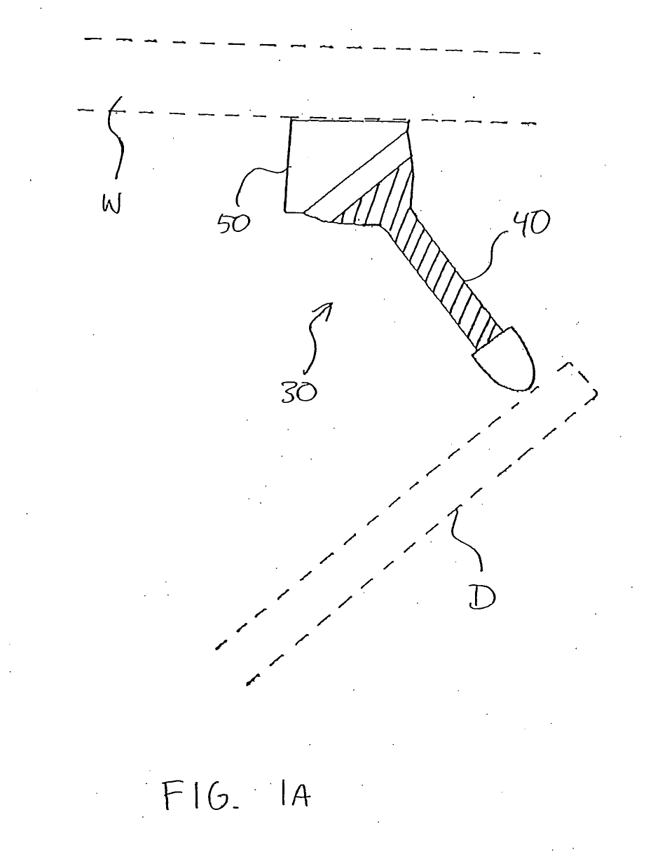

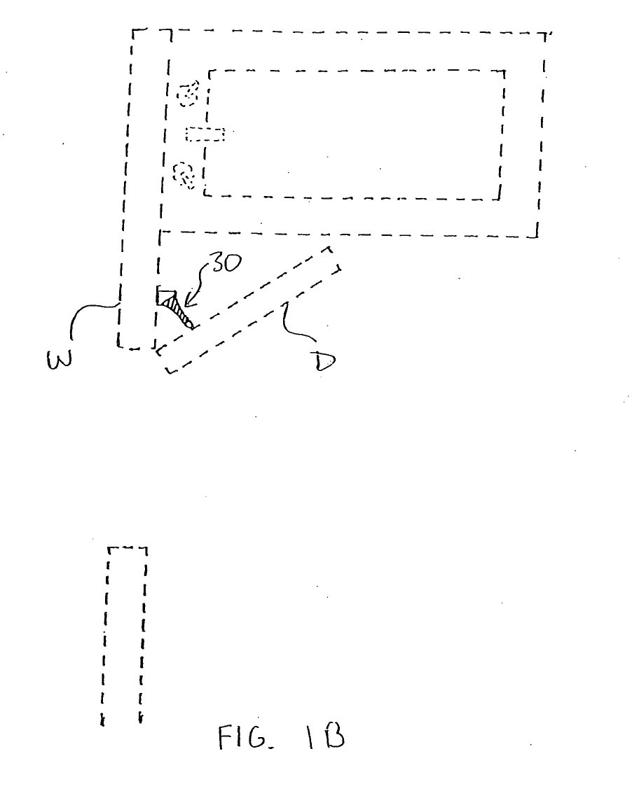

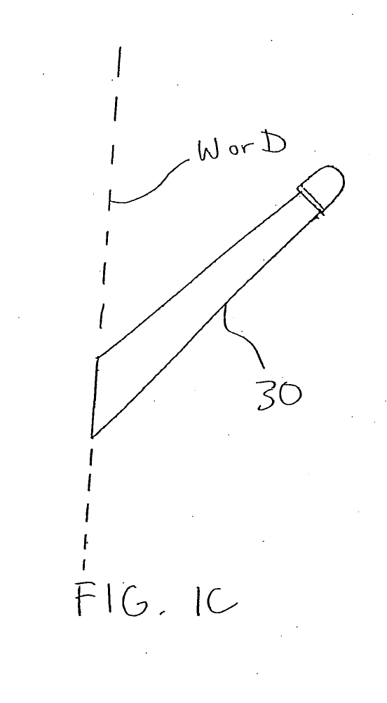

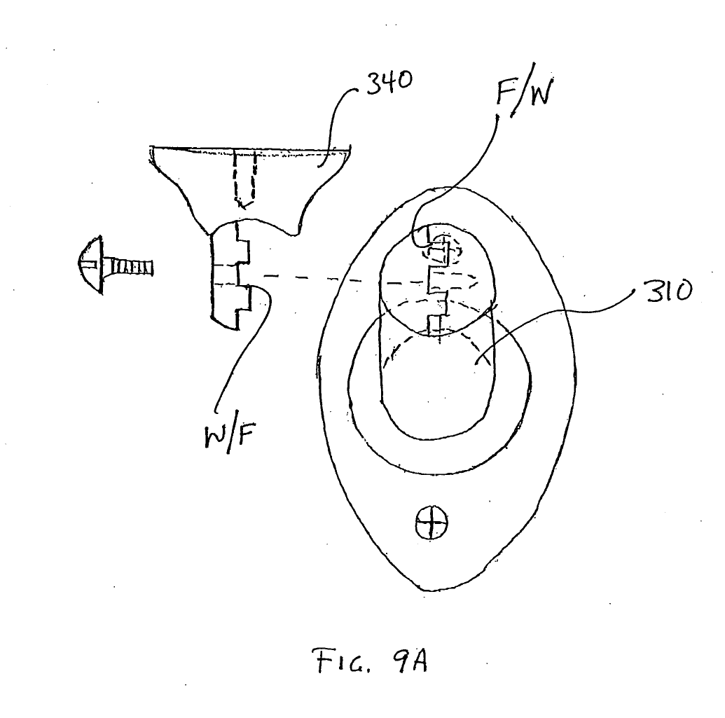

In describing the preferred and selected alternate embodiments of the present invention, as illustrated in FIGS. 1-13, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1A-4B, the present invention in a preferred embodiment is an apparatus 30 for protecting doors, door casings, door knobs and walls generally preferably possessing door bump angled block 50 and door bump 40. As best illustrated in FIG. 1A, door bump angled block 50 preferably changes the orientation of door bump 40 to protect the door and wall. Although it is preferred that apparatus 30 possess two components, namely door bump angled block 50 and door bump 40, it is contemplated in alternate embodiments that apparatus 30 comprise a single unit, such as, for exemplary purposes only, a door bump with a non-perpendicularly angled distal end, wherein said distal end mounts the door bump to the surface at a non-perpendicular angle relative to the wall or door. See FIG. 1C.

Furthermore, although it is preferred that apparatus 30 be placed on the lower base of the wall, it is contemplated in alternate embodiments that apparatus 30 be placed in other suitable positions, such as, for exemplary purposes only, towards the bottom of the door, towards the top of the door, on chair railing carried on the wall, or any other location along the wall. In the preferred embodiment, changing the orientation of door bump 40 to contact the door squarely allows door bump 40 to effectively dissipate the forces generated when the door strikes door bump 40.

Referring now to FIG. 1B, apparatus 30 is positioned on the wall, proximal to the door hinge. Changing the position of door bump 40 adjusts the extent to which a door may be opened, thereby protecting the door, door casing, door knob, wall and abutting object.

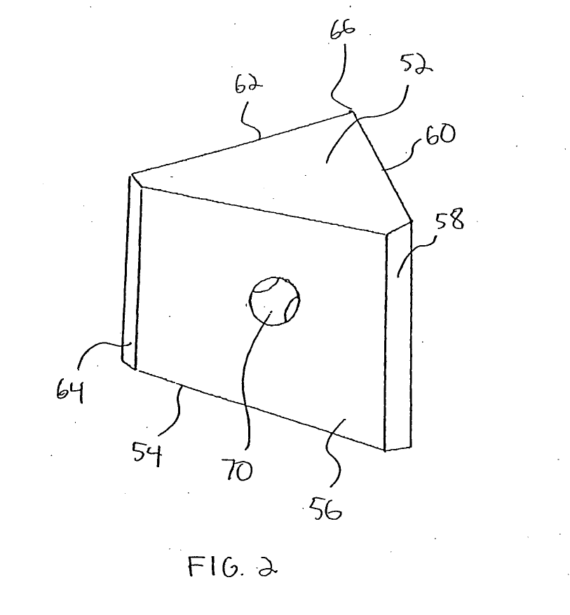

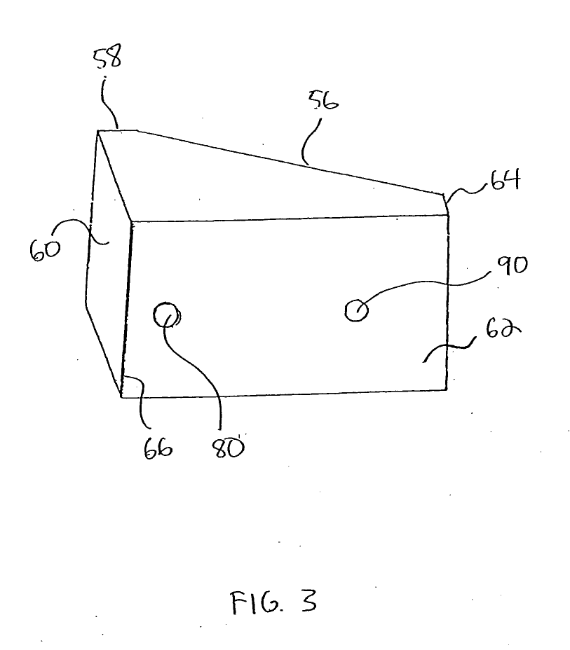

Referring now to FIG. 2, door bump angled block 50 is preferably substantially prism shaped and preferably comprises a top side 52, a bottom side 54, sidewalls 56, 58, 60, 62 and 64, wherein sidewall 56 is adjacent to sidewall 58 disposed at preferably an angle approximately equal to 135 degrees therefrom, sidewall 58 is adjacent to sidewall 60 disposed at preferably an angle approximately equal to 90 degrees therefrom, sidewall 60 is adjacent to sidewall 62 disposed at preferably an angle approximately equal to 90 degrees therefrom, sidewall 62 is adjacent to sidewall 64 disposed at preferably an angle approximately equal to 90 degrees therefrom, and sidewall 64 is adjacent to sidewall 56 disposed preferably at an angle approximately equal to 45 degrees therefrom. Sidewalls 56, 58, 60, 62 and 64, top side 52 and bottom side 54 together form door bump angled block 50.

It is recognized that door bump angled block 50, in alternate embodiments, may have sidewalls of varying lengths disposed at various angles. Door bump angled block 50 may define an alternate, suitable shape such as, for exemplary purposes only, triangle, parallelogram, pentagon, hexagon, or any other shape that has an angled surface relative to the wall mounted surface. Further, although it is preferred that door bump angled block 50 be formed from plastic material, it is contemplated in alternate embodiments that door bump angled block 50 be formed from any suitable material known within the art, such as, for exemplary purposes only, wood, metal or other materials or combinations thereof.

Sidewall 56 of door bump angled block 50 has disposed thereon a first end of aperture 70, wherein aperture 70 is preferably substantially circular shaped. Although it is preferred that aperture 70 is substantially horizontally aligned directly between top side 52 and bottom side 54, and vertically aligned directly between the right vertical edge of sidewall 64 and the left vertical edge of sidewall 58, it is contemplated in alternate embodiments that aperture 70 could be located anywhere on side wall 56 or that there could be more than one aperture 70.

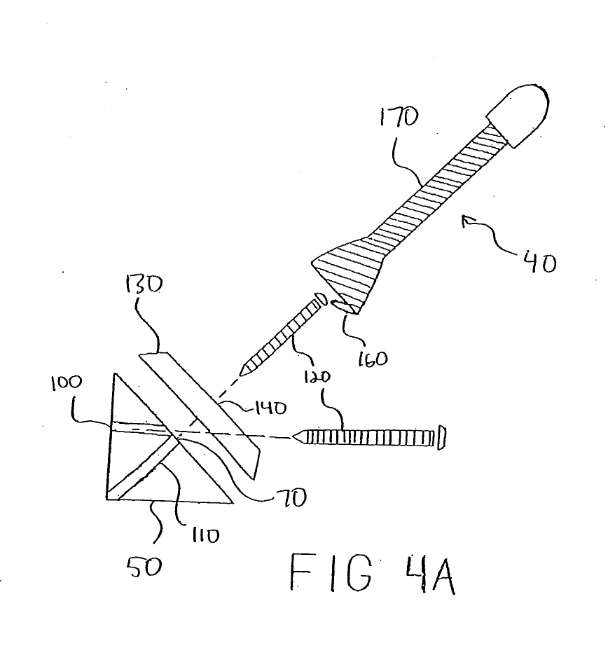

Referring now to FIG. 3, sidewall 62 of door bump angled block 50 has disposed thereon preferably two apertures 80 and 90, wherein aperture 80 is preferably substantially elliptical shaped and aperture 90 is preferably substantially circular shaped. Although it is preferred that apertures 80 and 90 are substantially horizontally aligned directly between top side 52 and bottom side 54 with aperture 80 proximally closer to vertical edge 66 relative to aperture 90, it is contemplated in alternate embodiments that apertures 80 and 90 could be placed anywhere on sidewall 62 and in any proximal relation to each other. It is further contemplated in alternate embodiments that sidewall 62 can have more than one aperture 90.

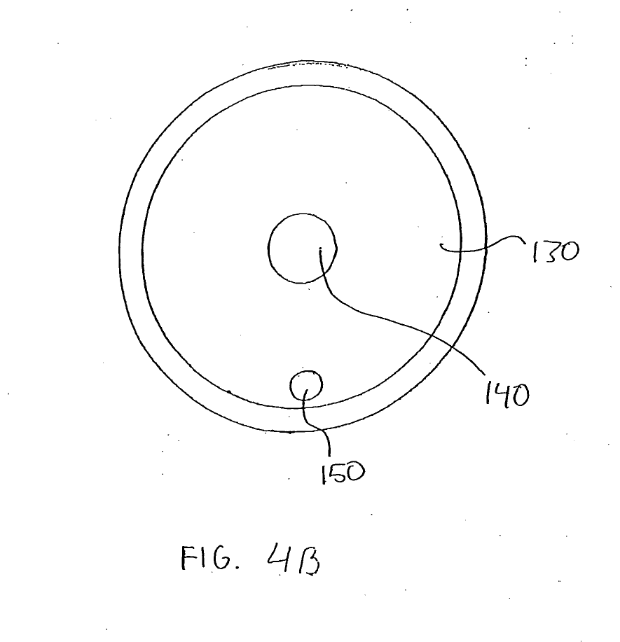

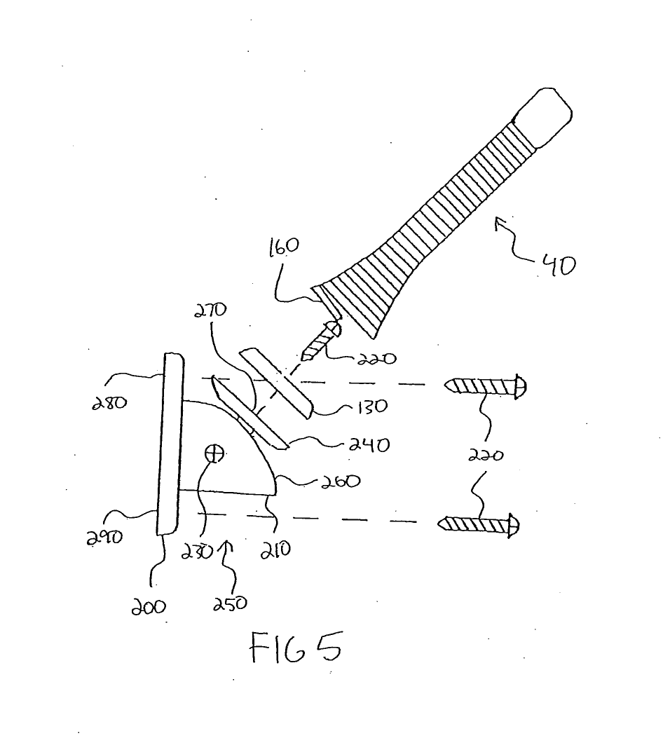

Referring now to FIG. 4A, formed within door bump angled block 50 are preferably two channels 100 and 110, wherein channel 100 has an opening at aperture 70 on one end and an opening at aperture 90 on the other end, and wherein channel 110 has an opening at aperture 70 on one end and an opening at aperture 80 on the other end. Although the preferred shapes of channels 100 and 110 are substantially cylindrical, it is contemplated in alternate embodiments that channels 100 and 110 could be any shape or size, so long as channels 100 and 110 are large enough to allow reception of attachment screws 120, yet narrow enough to allow attachment screws 120 to secure door bump angled block 50 to the wall or door. Additionally, although it is preferred that door bump angled block 50 possess two channels that overlap at aperture 70, it is contemplated in an alternate embodiment that door bump angled block 50 could contain any number of channels, and that any such channels can be alternately spaced or aligned, wherein at least one channel is used to attach door bump angled block 50 to the wall and wherein at least one channel is used to attach door bump angled block 50 to door bump 40. It is also contemplated that channel 110 not extend through sidewall 62 such that aperture 80 does not exist.

Preferably, attachment screws 120 have a length sufficiently long enough to extend through door bump angled block 50 to provide an adequate length beyond sidewall 62, sufficient to allow securing of door bump angled block 50 to a wall or door, wherein said attachment screws 120 are preferably dimensioned to be received within channel 100 or 110 and are capable of securing door bump angled block 50 to the wall, door or other surface. Although attachment screws 120 are preferably wood screws, it is contemplated in alternate embodiments that alternate means of attachment could be utilized, such as, for exemplary purposes only, machine screws, nails, rivets, glue, magnets, or the like. However, the use of wood screws allows the user to remove door bump angled block 50 from the wall or door, and relocate said door bump angled block 50 to another location on the wall or door.

As shown in FIG. 4B, door bump connector plate 130 is preferably a thin connector piece, wherein door bump connector plate 130 has disposed thereon preferably two apertures 140 and 150. Although it is preferred that door bump connector plate 130 be formed from metal material, it is contemplated in alternate embodiments that door bump connector plate 130 be formed from any suitable material known within the art, such as, for exemplary purposes only, wood, plastic or other synthetic material. Further, although it is preferred that door bump connector plate 130 be substantially circular, it is contemplated in alternate embodiments that door bump connector plate 130 may define an alternate shape, so long as door bump connector plate 130 has a shape that is suitable to connect door bump 40 to door bump angled block 50.

Preferably, aperture 140 is located in the center of door bump connector plate 130 and aperture 150 is located towards the periphery of door bump connector plate 130. Although it is preferred that apertures 140 and 150 be substantially circular, it is contemplated in alternate embodiments that apertures 140 and 150 could be any shape or size, so long as aperture 140 is large enough to allow attachment screw 120 to penetrate it, yet narrow enough to allow attachment screw 120 to secure door bump connector plate 130 to door bump angled block 50, and so long as aperture 150 has a size and shape that is dimensioned to receive terminal end 160 of tapered coil 170 of door bump 40.

Although door bump 40 is preferably a rubber cap fixed to the end of a tapered coil, it is contemplated in alternative embodiments that door bump 40 is any device capable of dissipating the forces generated when the door or door knob strikes the wall or door casing such as, for exemplary purposes only, a spring, air bag or Styrofoam.

To secure door bump angled block 50 to the wall or door, attachment screw 120 is inserted into aperture 70 of door bump angled block 50 so that attachment screw 120 passes through channel 100 and protrudes out of sidewall 62 through aperture 90, wherein attachment screw 120 engages the wall or door. Notably, channel 100 is of a sufficient size and is in a position relative to channel 110 that complete insertion of attachment screw 120 into channel 100 does not block channel 110.

To secure door bump 40 to door bump angled block 50, another attachment screw 120 is inserted into aperture 140 of door bump connector plate 130 and then inserted into aperture 70 of door bump angled block 50 so that attachment screw 120 passes through channel 110 and protrudes out of sidewall 62 through aperture 80, wherein attachment screw 120 engages the wall or door. Terminal end 160 of door bump 40 is then inserted into aperture 150 of door bump connector plate 130 to attach door bump 40 to door bump angled block 50. It is contemplated in an alternate embodiment that door bump 40, connector plate 130 and attachment screw 120 are combined to form a unitary structure, wherein said unitary structure is attached to door bump angled block 50 to form apparatus 30.

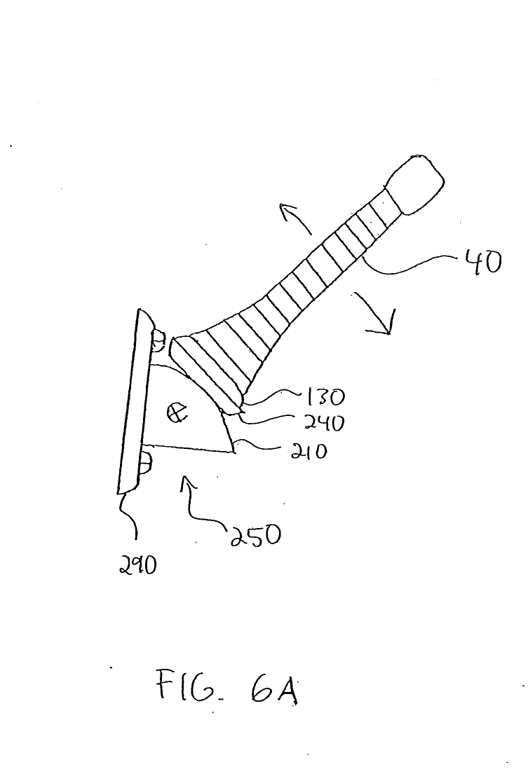

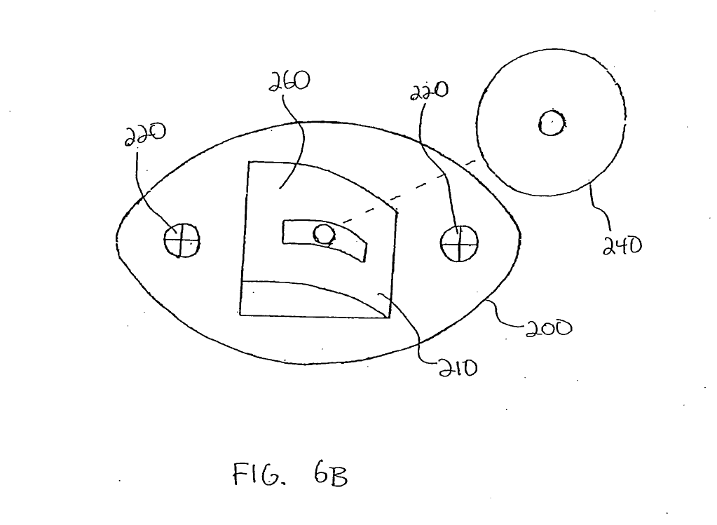

Referring now to FIGS. 5-6B, in an alternate embodiment, door bump angled block 250 could have a shape wherein three-dimensional semicircle or quarter-circle 210 is permanently joined to flat plate 200. It is further contemplated in alternate embodiments that flat plate 200 may define an alternate shape, such as, for exemplary purposes only, circular, rectangular or eye-shaped. Furthermore, flat plate 200 has an aperture 280 or 290 disposed thereon on either side of three-dimensional semicircle or quarter-circle 210, wherein said aperture 280 or 290 is of a suitable shape and size to allow insertion of attachment screws 220, and wherein attachment screws 220 secures flat plate 200 of door bump angled block 250 to the wall or door.

It is further contemplated that door bump angled block 250 has a pivotable hinge 230 wherein base connector 240 of door bump angled block 250 can pivot along outer surface 260 of said three-dimensional semicircle or quarter-circle on a horizontal axis. Pivotable hinge 230 can employ any number of pivoting mechanisms, such as, for exemplary purposes only, a plurality of mated wheels with toothed faces or a frictional fitting pivotable hinge. Moreover, pivotable hinge 230 comprises a locking mechanism to fix base connector 240 into a locked position. Such locking mechanisms include, but are not limited to, screw locks, cam locks, stops or detents.

Base connector 240 of door bump angled block 250 has disposed thereon aperture 270, wherein aperture 270 is of a suitable shape and size to allow insertion of another attachment screw 220, and wherein said attachment screw 220 attaches door bump connector plate 130 to base connector 240 of door bump angled block 250. Terminal end 160 of door bump 40 is then inserted into aperture 150 of door bump connector plate 130 to attach door bump 40 to door bump angled block 250. Thus, door bump angled block 250, in this embodiment, can position door bump 40 in various angles relative to the door and wall. This allows the user to use this device on any door or wall in a building.

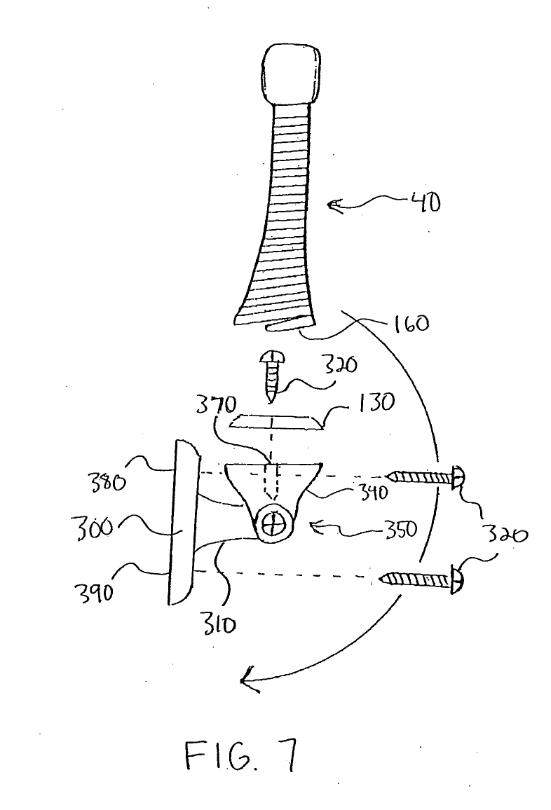

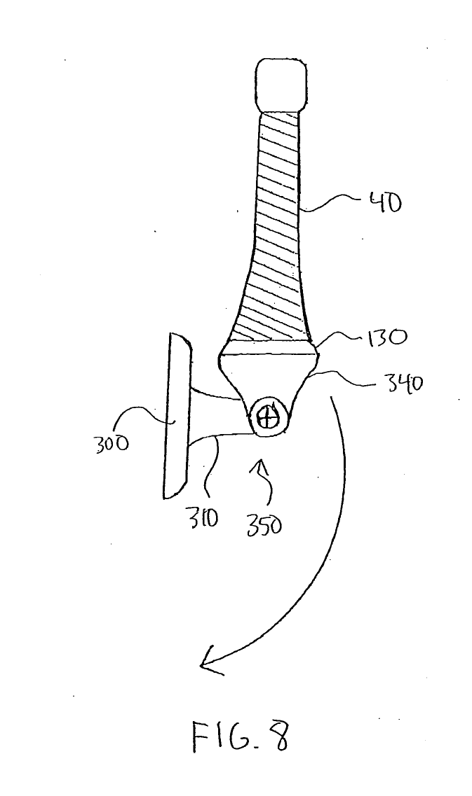

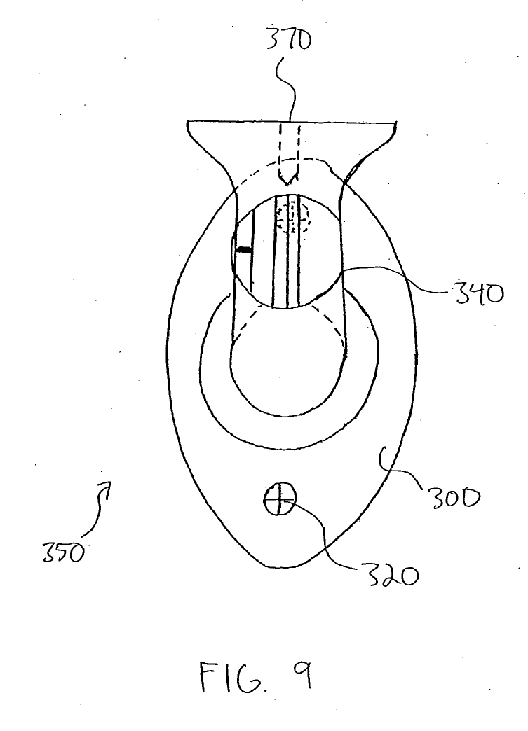

Referring now to FIGS. 7-9, in an alternate embodiment, door bump angled block 350 could have a shape wherein post 310 is permanently joined to flat plate 300. It is further contemplated that flat plate 300 may define an alternate shape, such as, for exemplary purposes only, circular, rectangular or eye-shaped. Furthermore, flat plate 300 has apertures 380 and 390 disposed thereon on either side of post 310, wherein said apertures 380 and 390 are of a suitable shape and size to allow insertion of attachment screws 320, and wherein attachment screws 320 secures flat plate 300 of door bump angled block 350 to the wall or door.

Post 310 is generally conical shaped, wherein base connector 340 is pivotably attached to the terminal end of post 310. It is contemplated in alternate embodiments that post 310 can be any shape or size, such as, for exemplary purposes only, a cylinder, block or pyramid. It is further contemplated that any number of pivoting mechanisms can be used, such as, for exemplary purposes only, a hinge pin, a plurality of mated wheels with toothed faces, or a frictional fitting pivotable hinge. Moreover, door bump angled block 350 can comprise a locking mechanism to fix base connector 340 into a locked position. Such locking mechanisms include, but are not limited to, screw locks, cam locks, stops or detents.

Base connector 340 of door bump angled block 350 has disposed thereon aperture 370, wherein aperture 370 is of a suitable shape and size to allow insertion of another attachment screw 320, and wherein said attachment screw 320 attaches door bump connector plate 130 to base connector 340 of door bump angled block 350. Terminal end 160 of door bump 40 is then inserted into aperture 150 of door bump connector plate 130 to attach door bump 40 to door bump angled block 350. Thus, door bump angled block 350, in this embodiment, can position door bump 40 in various angles relative to the door and wall. This allows the user to use this device on any door or wall in a building.

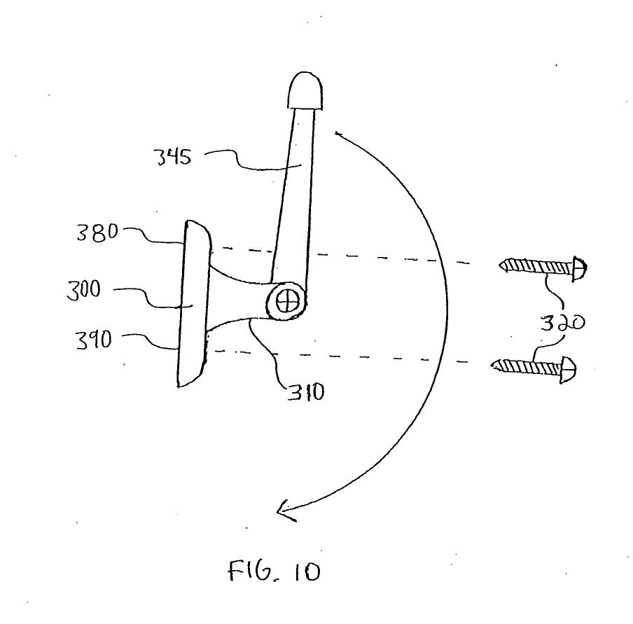

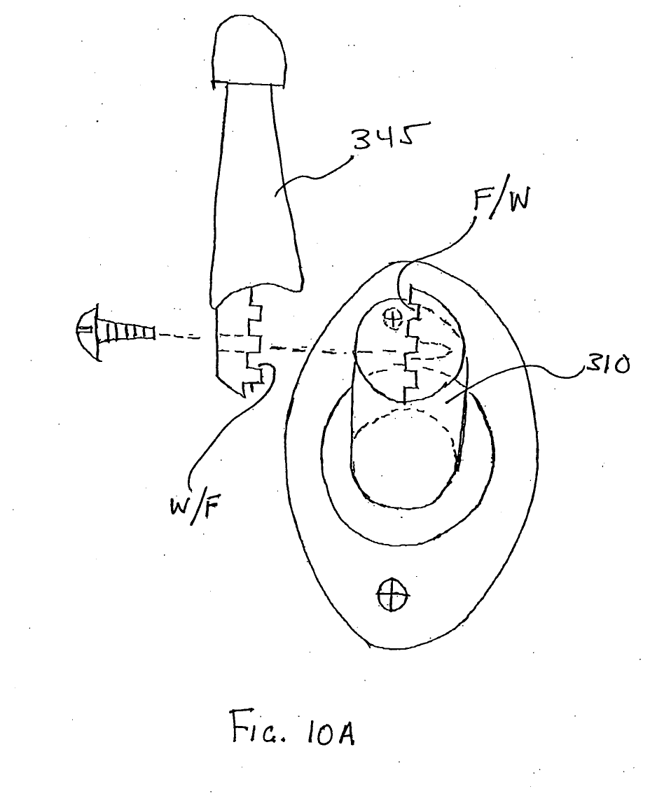

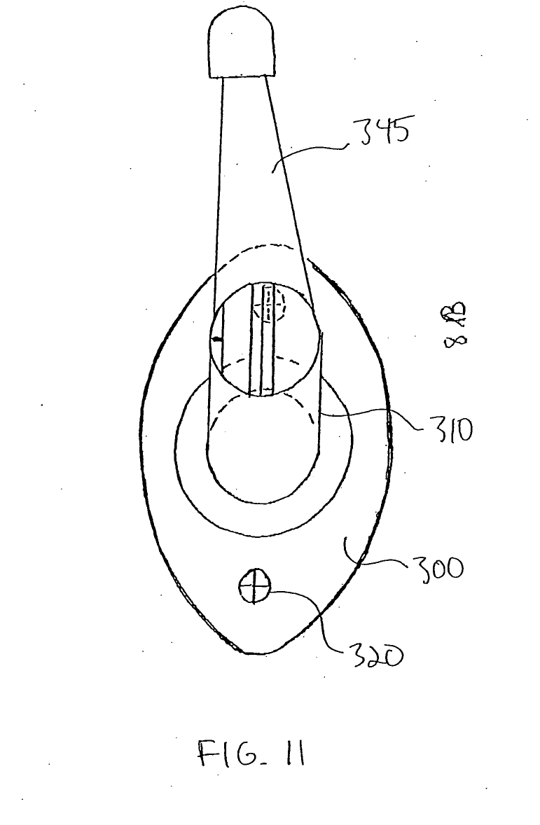

Referring now to FIGS. 10-11, in an alternate embodiment, door bump 345 is pivotably attached to the terminal end of post 310. It is contemplated that any number of pivoting mechanisms can be used, such as, for exemplary purposes only, a hinge pin, a plurality of mated wheels with toothed faces, or a frictional fitting pivotable hinge. Moreover, post 310 can comprise a locking mechanism to fix door bump 345 into a locked position. Such locking mechanisms include, but are not limited to, screw locks, cam locks, stops or detents. Thus, post 310, in this embodiment, can position door bump 345 in various angles relative to the door and wall.

Door bump 345, in this embodiment, comprises a rubber cap fixed to the terminal end of a substantially cylindrical shaped rod. It is further contemplated in alternate embodiments that door bump 345 could comprise any number of suitable components known within the art to facilitate the purpose of dissipating the forces generated when a door strikes a door bump.

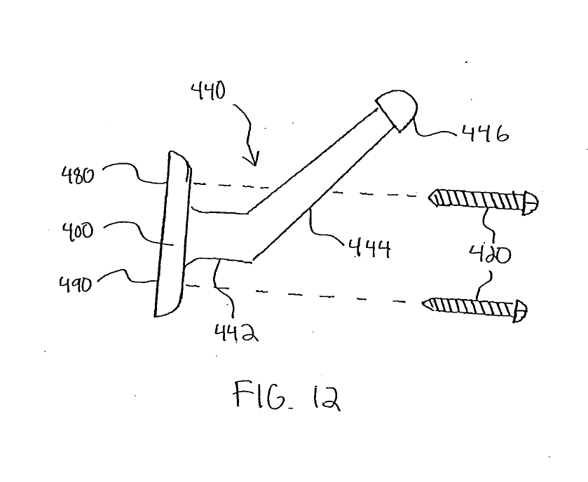

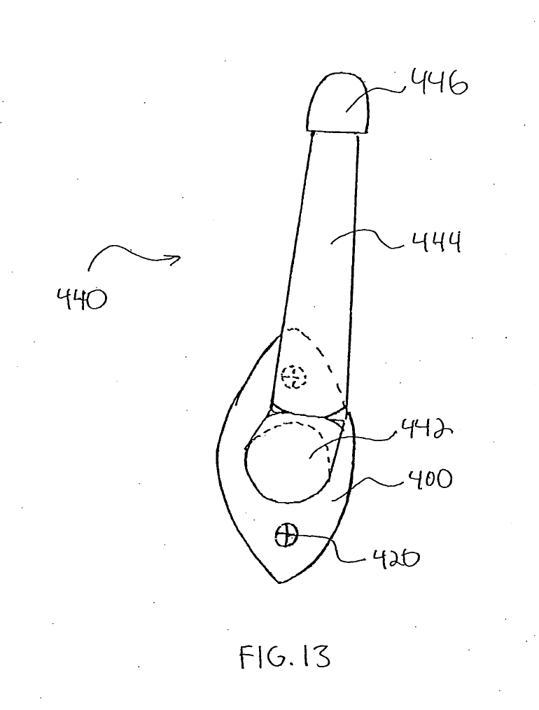

Referring now to FIGS. 12-13, in an alternate embodiment, apparatus 430 comprises door bump 440, wherein door bump 440 is permanently joined to flat plate 400. It is further contemplated in alternate embodiments that flat plate 400 may define an alternate shape, such as, for exemplary purposes only, circular, rectangular or eye-shaped. Moreover, flat plate 400 has apertures 480 and 490 disposed thereon on either side of door bump 440, wherein said apertures 480 and 490 are of a suitable shape and size to allow insertion of attachment screws 420, and wherein attachment screws 420 secures flat plate 400 to the wall or door.

Door bump 440, in this embodiment, comprises post 442, rod 444 and rubber cap 446, wherein the distal end of post 442 is permanently joined to flat plate 400 at an angle perpendicular to the mounted plane of flat plate 400. Furthermore, rubber cap 446 is fixed to the terminal end of rod 444, wherein the opposite end of rod 444 is permanently joined to post 442 at a non-parallel angle. Thus, apparatus 430, in this embodiment, can position rubber cap 446 relative to the wall or door so that the wall or door will contact the rubber cap squarely, thereby protecting the door, door casing, door knob and wall.

Although apparatus 30 of the preferred and alternate embodiments provides generally first component door bump 40 and second component door bump angled block 50, it is contemplated in an alternate embodiment that apparatus 30 could comprise any number of components to facilitate the purpose of protecting doors, door casings, door knobs and walls.

In another alternate embodiment, apparatus 30 could be applied to other articles having doors such as, for exemplary purposes only, storage bins, cabinets, refrigerators, washer-dryer units, stove-oven units, or the like.

In another alternate embodiment, door bump angled block 50 could be decorative.

In another alternate embodiment, door bump angled block 50 could be manufactured from an opaque or transparent material to conceal its presence.

In yet another alternate embodiment, door bump angled block 50 could be dome shaped.

In still another alternate embodiment, door bump 40 could have extending and retracting or telescoping capabilities.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. An apparatus for protecting doors, door casings, door knobs and walls having a surface, said apparatus comprising:
at least one door bump; and
a means for mounting said at least one door bump on a surface at a non-perpendicular angle from the surface, wherein said means for mounting said at least one door bump on a surface is an angled block, wherein said angled block comprises a wall or door mounting surface and a door bump mounting surface, and wherein said wall or door mounting surface is at a non-perpendicular angle to said door bump mounting surface, and wherein said angled block comprises means for adjusting the angular position of said door bump relative to the surface, and wherein said means for adjusting the angular position of said door bump is a plurality of mated wheels with toothed faces.

2. The apparatus of claim 1, wherein said means for mounting includes a non-perpendicularly angled distal end of said door bump.

3. (canceled)

4. (canceled)

5. (canceled)

6. (canceled)

7. The apparatus of claim 1, further comprising a connector plate for connecting said door bump to said angled block.

8. The apparatus of claim 1, wherein said angled block has formed therein at least one channel dimensioned to receive a securing means there through to attach said angled block to the surface.

9. The apparatus of claim 8, wherein said angled block has formed therein at least one channel dimensioned to receive a securing means there through to attach said angled block to said connector plate.

10. (canceled)

11. The apparatus of claim 9, wherein said at least one channel to attach said angled block to the surface and said at least one channel to attach said angled block to said connector plate converge at a single aperture on said door bump mounting surface.

12. A method for protecting doors, door casings, door knobs and walls, comprising the step of:
mounting at least one angled block to a surface such as a door or a wall, wherein a door bump extends therefrom at a non-perpendicular angle; and
adjusting the angular position of said door bump via a plurality of mated wheels with toothed faces.

13. (canceled)

14. The method of claim 12, further comprising the step of mounting said door bump to said angled block.

15. (canceled)

16. An apparatus for protecting doors, door casings, door knobs and walls having a surface, said apparatus comprising:
at least one door bump;
a means for mounting said at least one door bump on the surface at a non-perpendicular angle from the surface; and
a means for adjusting angular position of said at least one door bump, wherein said adjusting means is a plurality of mated wheels with toothed faces.

17. The method of claim 12, wherein said door bump has a non-perpendicularly angled distal end.
